(19) United States
(12) Patent Application Publication
(10) Pub. No.: US 2020/0011075 A1
(43) Pub. Date: Jan. 9, 2020

(54) METHOD OF REMOVING MICROFRACTURES FROM CONCRETE SUBJECTED TO IMPACT METHODS OF CONCRETE DEMOLITION AND APPARATUS FOR PRACTICING THE METHOD

(71) Applicant: RESTORATION EAST, LLC, Rosedale, MD (US)

(72) Inventor: William W. Hach, Rosedale, MD (US)

(21) Appl. No.: 16/028,549

(22) Filed: Jul. 6, 2018

(51) Int. Cl. E04G 23/08

(52) U.S. Cl. CPC E04G 23/081; B26F 3/004

(57) ABSTRACT

A robot includes a movable vehicle to which is mounted a horizontal truss long enough to span the entire width of an area that has been demolished using impact methods. The truss extends laterally completely to one side of the robot and the robot travels on one side of a demolished area and the end of the truss has a wheeled support that can travel beyond the other side of a demolished area. A movable rotational lance device is traversed back and forth along the truss. With each pass the robot then moves perpendicular to the truss. The truss has a nozzle spraying water onto the area. In this way, an entire area is efficiently treated.

### BACKGROUND OF THE INVENTION

The present invention relates to a method of removing microfractures from concrete subjected to impact methods of concrete demolition (e.g., jackhammering) and apparatus for practicing the method. This invention involves a modified hydrodemolition procedure. Hydrodemolition is a well known and practiced technique for removing layers of reinforced concrete so that repairs can be done to a volume of concrete located on horizontal or vertical surfaces. In this regard, U.S. Pat. No. 7,080,888 to Hach and U.S. Pat. No. 8,864,240 to Hach are referenced.

Hach '888 discloses a dual nozzle hydro-demolition system in which a robot vehicle has a carriage mounted on a beam supported on a vertical boom and designed to traverse horizontally to hydro-demolish a vertical surface above the robot.

Hach '240 discloses a further robot for hydrodemolition of concrete that includes a horizontally mounted track with a boom able to descend vertically to allow hydrodemolition of concrete below the track such as at the location of a dam or other vertical structure.

Neither of these patents teaches or suggests how to address the problem of microfracture caused by impact concrete removal methods like use of chipping hammers or jackhammering which can result in weakening of concrete installed to replace concrete that has been demolished from a volume of concrete on a structure.

When new concrete is applied over structural steel and portions of previously placed concrete, if there are microfractures in the previously placed concrete resulting from the demolition of surrounding areas of concrete, these microfractures inherently reduce the bonding strength to a level below what is required, for example, in a parking deck, where vehicles of different sizes and weights will be supported on a number of elevations of parking deck.

ASTM International (ASTM) provides standard test methods for determining the tensile strength of concrete surfaces and the bond strength or tensile strength of concrete repair and overlay materials. ASTM is a well known and well established organization which provides standards to the industry that may be followed to ensure that various aspects of construction meet recognized structural standards.

ASTM maintains an Internet website at www.astm.org where their standards are published. Testing in accordance with ASTM's standards is well known and well understood by those of ordinary skill in the art. When such testing is carried out, what is being sought is the tensile strength of the concrete material in pounds per square inch (psi).

Knowledge of the need for the present invention arose when Applicant began conducting a concrete restoration in a multi-floor parking garage. A first area encompassing about 5,000 square feet was first subjected to a hydrodemolition using a robot in which high pressure water was sprayed out of rotating nozzles to break up the concrete surface and facilitate its removal. After the hydrodemolition was completed, additional detail demolition was required using impact hammers. Applicant found that the slabs being treated had a good number of high strength patches that could not be removed through hydrodemolition and so impact hammers were used to chip away at those areas. Applicant found that the original steel reinforcement placement varied dramatically from area to area and chipping hammers were employed to provide the required rebar clearances of approximately ¾ inch.

Following ICRI guidelines, Applicant observed that the chipping hammers created microfractures in the bonding surface. About 60% of the bonding surface had microfractures created by the impact removal methods that occurred after hydrodemolition was undertaken. Applicant also found that it was next to impossible to record and locate which areas were only subjected to hydrodemolition and which areas were subjected to both hydrodemolition and chipping with impact hammers. Thus, after these processes were completed, the entire bonding surface was sandblasted in an effort to remove microfractures that would inhibit a strong bond between the existing concrete and concrete to be newly poured.

After the slab surface was cleaned to be spotless with no slurry or debris that would interfere with a new concrete bond, repair concrete was placed in accordance with ICRI guidelines. When this was competed, 7-day tensile strength testing was undertaken using ASTM standard C-1583 to determine the bonding strength. The required bond strength was at least 140 psi, however, these tests revealed that the bonding strength averaged below 100 psi. These results were unacceptable and Applicant determined that the reason for this low result was microfracturing which could not be identified during the process undertaken.

In an attempt to solve this problem of low tensile strength, a second 500 square foot area was treated. First hydrodemolition was carried out and then chipping hammers were employed in areas where necessary and then a 100% re-sounding of the entire slab surface was performed which revealed about 30 areas of delamination, each the size of a hockey puck. These areas could not be readily visually identified.

These 30 small areas were then chipped out with chipping hammers and then the entire slab was subjected to a heavy sandblast treatment. These efforts increased the tensile strength as compared to the first area treated, but the 7-day tensile strength only averaged 128 psi in accordance with the ASTM C-1583 pull out test. One of the areas still had a tensile strength below 100 psi.

These results indicated to Applicant that there were still microfractures resulting from the impact demolition which were not readily detectable. A solution had to be found to eliminate these microfractures so that new concrete could be poured having a tensile strength of at least 140 psi as required. The present invention was developed to solve this problem and to provide high tensile strength concrete at the job site.

### SUMMARY OF THE INVENTION

The present invention relates to a method of removing microfractures from concrete subjected to impact demolition and apparatus for practicing the method. The present invention includes the following interrelated objects, aspects and features:

(1) In a first aspect, the present invention contemplates creation of a new robot. This new robot includes a movable vehicle to which is mounted a horizontal truss. The horizontal truss is long enough to span the entire width of an area that has been demolished using impact methods.

(2) The robot is designed so that the truss extends laterally completely to one side of the robot so that the robot can travel on one side of a demolished area and the end of the truss can have a wheeled support that can travel beyond the other side of a demolished area.

(3) In practicing the teachings of the present invention, the truss has mounted thereon a movable high speed rotational lance device that may systematically be traversed back and forth along the truss. With each pass of the lance over a certain area that has been demolished, the robot then moves perpendicular to the truss, for example, an inch whereupon the lance traverses the truss again spraying high pressure water from a nozzle onto the area. In this way, as the lance traverses back and forth along the truss and the robot indexes the location of the truss inch by inch, an entire area can efficiently be treated using this new inventive robot.

(4) The inventive robot is more effective than conventional hydrodemolition robots used in earlier steps in the process because once demolition of an area of concrete has been performed, the conventional hydrodemolition robots can no longer be used in the demolished area because their weight and construction will result in bending and wrecking the exposed reinforced steel that will be used to reinforce the replacement concrete that is to be placed since they don't have a laterally spaced truss.

(5) When the inventive method was performed on an area of concrete first hydrodemolished, then sandblasted, then treated with chipping hammers, and then treated using the inventive robot, when new concrete was poured, 7-day tensile strength tests revealed no area having a tensile strength below 145 psi.

(6) Applicant has found that varying the lance's settings, including dwell time, pressure, volume, and jet angle, will result in more comprehensive microfracture removal without overexcavating the sound concrete in the substrate. The precise variations depend on a number of factors, including relative concrete strength and cement concentration. Applicant has also found that varying the settings of the lance increases the 7-day tensile strength to at least 175 psi.

As such, it is a first object of the present invention to provide a method of removing microfractures from concrete subjected to impact demolition and apparatus for practicing the method without overexcavating the sound concrete substrate.

It is a further object of the present invention to provide such an apparatus and method in which a robot is provided having a horizontally disposed truss extending laterally from one side of the robot.

It is a further object of the present invention to provide such a robot in which a lance is controllably moved traversing back and forth along the truss while spraying high pressure water through a rotating nozzle.

It is a yet further object of the present invention to provide such a robot which may index the position of the robot inch by inch along an area to be treated so that the lance moving back and forth along the truss can spray high pressure water on every square inch of the area to be treated.

It is a still further object of the present invention to provide such an apparatus and method in which the result is dramatic reduction of microfractures in concrete structures being treated, nowhere previously contemplated in the industry.

These and other objects, aspects and features of the present invention will be better understood from the following detailed description of the preferred embodiment when read in conjunction with the appended drawing figures.

### BRIEF DESCRIPTION OF THE DRAWINGS

FIG. 1 shows a perspective view of a concrete surface, a portion of which has been treated in accordance with the teachings of the present invention.

FIG. 2 shows an end view of the portion of concrete illustrated in FIG. 1, also showing the inventive robot in place where it is performing the inventive method.

FIG. 3 shows a close-up view of the lance and shield along with a portion of the elongated truss that supports the lance and shield.

FIG. 4 shows a side view of the inventive robot, truss, and lance.

FIG. 5 shows a top view of the robot, truss, and lance shown in FIG. 4.

### SPECIFIC DESCRIPTION OF THE PREFERRED EMBODIMENT

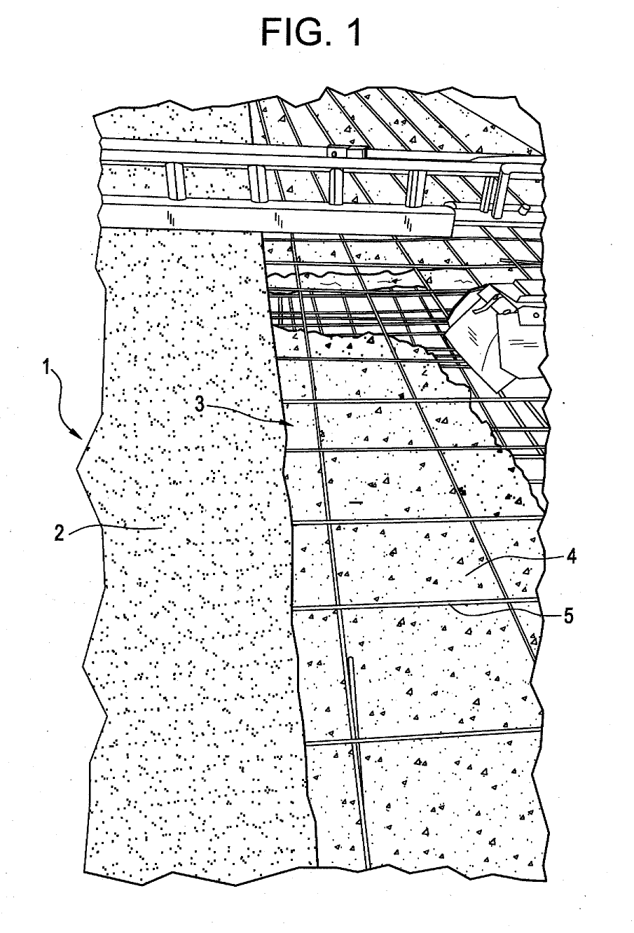

With reference first to FIG. 1, an area of concrete is generally designated by the reference numeral 1 and is seen to include a first region 2 where demolition has not yet taken place, and an area 3 where demolition has taken place and the inventive robot is in operation. The region 3 shows a reduced elevation portion of concrete 4 and the demolition has exposed a lattice work of reinforcing rebar 5 which will be reused in accordance with the teachings of the present invention.

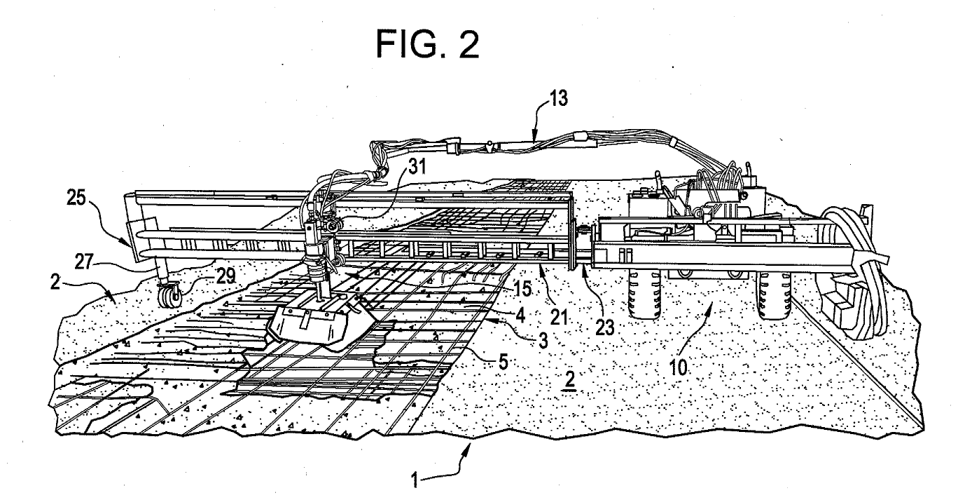

With reference to FIG. 2, the same area 1 is shown but additionally, the inventive robot 10 is also visible.

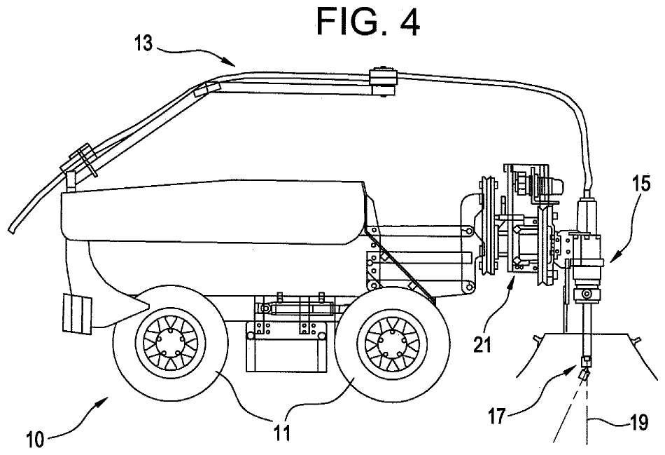

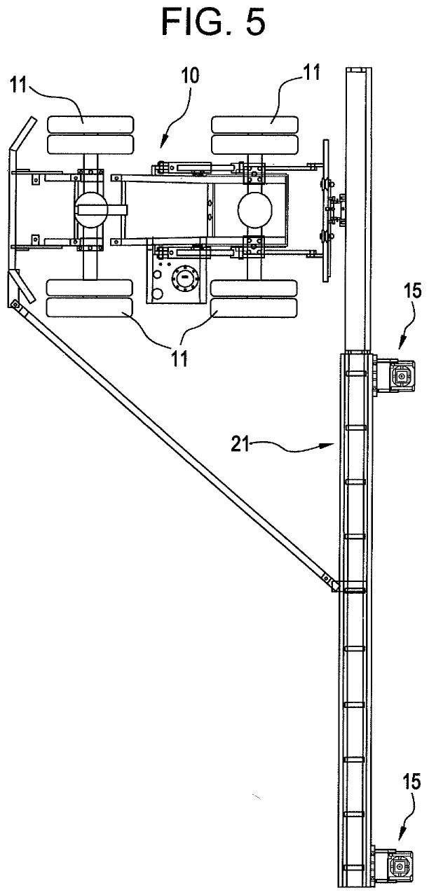

The robot 10 is also seen in particular as an overview in FIGS. 4 and 5. With reference to FIGS. 2, 4 and 5, the robot 10 is supported on tires 11 and a drive mechanism (not shown in detail) is provided to allow controlled rotation of the tires 11 to move the robot 10 as desired. FIG. 2 shows a bundle 13 of conduits extending between the robot 10 and the lance which is generally designated by the reference numeral 15. The bundle of conduits 13 includes conduits supplying hydraulic fluid to a hydraulic motor on the lance 15 that facilitates rapid rotation of the nozzle 17 which is seen in FIG. 4 and is preferably angled at an angle of 25° with respect to a vertical axis 19 so that when the nozzle 17 is rotated, it emits water at high pressure over a wider area than would be the case if it was not angulated with respect to the axis 19. Another conduit within the bundle of conduits 13 supplies high pressure water to the nozzle 17 which is emitted as the lance 15 moves along the truss 21.

As best seen in FIG. 2, the truss 21 is attached to the robot 10 at a first end 23 and extends a considerable distance to a second end 25 remote from the robot 10 where a support post 27 and wheel assembly 29 are provided to support the end 25 of the truss 21 in a position beyond the edge of the area of concrete being treated in accordance with the teachings of the present invention. As shown in FIG. 2, the robot 10 is located to one side of the area of concrete and the end 25 of the truss 21 is located at another side of the area of concrete, the truss 21 suspended over the area of concrete.

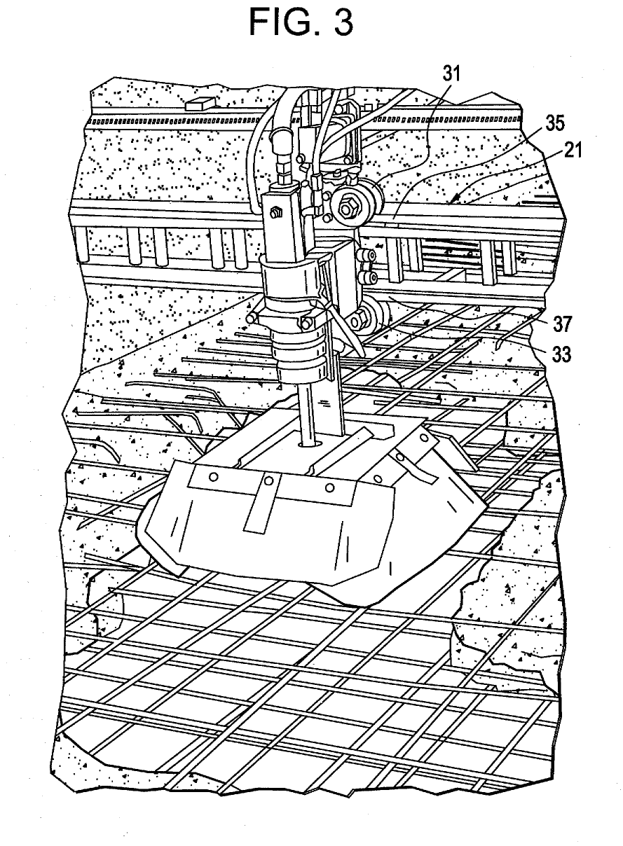

As briefly explained above, the rotation of the nozzle 17 is accomplished through use of a pump supplying hydraulic fluid to a motor at the lance 15 that rotates the nozzle 17. High pressure water is supplied in one of the conduits of the bundle of conduits 13. The lance 15 travels back and forth along the truss 21 by virtue of wheels 31, 33 (FIGS. 2 and 3) which ride on respective tracks 35 and 37 at the top and bottom of the truss 21. These wheels are operated either by a hydraulic motor or an electric motor which is controlled by a computer to rotate back and forth.

The robot 10 is also programmed to coordinate with movements of the lance 15 back and forth along the truss 21. In this regard, the computer (not shown) can easily be programmed by one of ordinary skill in the art so that the position of the robot 10 along the area 3 where concrete is to be treated can be coordinated with movements of the lance 15 so that, for example, each time the lance 15 travels from one end 23 of the truss to the other end 25 of the truss, the wheels 11 are caused to move to index the position of the robot 10 by a desired distance, for example, one inch. If desired, this indexing of the position of the robot 10 can be adjusted each time the lance 15 goes back and forth along the truss 21 rather than just from one end to the other.

U.S. Pat. No. 7,080,888 to Hach, described above, includes a detailed disclosure of the manner by which a robot may be moved, nozzles may be rotated, and pressurized fluid may be supplied to a nozzle as well as the manner by which a nozzle may be moved along a beam. These aspects of the disclosure of this patent are fully incorporated by reference in the present specification and demonstrate that these details are well understood by those of ordinary skill in the art. In the present invention, the nozzle 17 can be rotated from 75 to 300 rpm and water pressure can be up to in the range of 20,000 psi. 25-33 gallons/minute of water may be supplied to the nozzle 17.

With the inventive robot being described in detail, the method of using it to great advantage will now be described in detail.

First, an area of concrete where replacement is necessary, is identified. As a first step, impact demolition methods are used to remove concrete. Sometimes this occurs by simply jackhammering to the appropriate depth. Sometimes, it involves a first pass of hydrodemolition which removes much of the old concrete and results in an erratic cut which causes a number of high spots that must be hammered out. It is often the case that the original steel placement varies dramatically from area to area and customers typically require ¾ inch bar clearances for the rebar and so after the hydrodemolition, impact hammers are employed to attempt to chip out concrete that remains in place. This hammering operation, either employed on its own or after a first pass of hydrodemolition, creates microfractures in the bonding surface.

Thus, the next step in the method is to sandblast the entire bonding surface to remove microfractures that would inhibit a strong bond between the new and old concrete. As noted above, however, the sandblasting method has been shown not to remove adequately all the microfractures necessary to achieve the required tensile strength.

Thus, the inventive robot is next accessed and it is located with the robot vehicle to one side of the area that has already been subjected to demolition and the truss is extended over that area with the wheels 29 supporting the far end 25 of the truss 21 beyond the portion that has been demolished on solid flat concrete. It is noted that Applicant's conventional hydrodemolition robot cannot traverse the area that has been demolished, because that robot is designed to be located on top of an uncut surface; using it on a demolished area would result in an unstable situation including erratic operation and the tendency of rebar to be bent by the heavy machine.

The inventive robot is activated and through use of a hydraulic pump, conduit, motor combination, the nozzle 17 is rapidly rotated while high pressure water is supplied to the nozzle 17. At the same time, the lance 15 is reciprocated back and forth along the truss 21 from the end 23 to the end 25, and then back to the end 23. As this reciprocation takes place, with each pass over the area to be treated, the position of the robot 10 is indexed in a desired direction by a desired increment, for example, one inch.

In this way, the entire area previously treated by chipping hammers and sandblasting is again treated with high pressure water to remove any remaining microfractures from the concrete material remaining in place. This is accomplished without doing any damage or bending in any way the rebar that is in place or overexcavating the sound concrete substrate.

Once this step is completed, the contractor may repair the area by adding forms that cover open areas at the bottom of the concrete such as shown in FIGS. 1-3 and replacement concrete is poured with the existing rebar 5 embedded therein.

Once this process is completed, and the concrete has appropriately cured, tensile strength bonding tests are conducted in accordance with ASTM procedure C-1583. Applicant has found that such tests will result in a reading of at least 145 psi for the 7-day tensile strength, significantly higher than it was ever before possible to achieve using conventional methods.

As such, an invention has been disclosed in terms of a method of removing microfractures from concrete subjected to demolition and the apparatus for practicing the method of great novelty and utility.

Of course, various changes, modifications, and alterations in the teachings of the present invention may be contemplated by those of ordinary skill in the art without departing from the intended spirit and scope thereof.

As such, it is intended that the present invention only be limited by the terms of the appended claims.

1. An apparatus for removing microfractures from an area of concrete that has been partially demolished using impact methods, comprising:
a) a robot that is movable under control of an operator to one side of said area of concrete;
b) a truss mounted to a side of said robot and extending horizontally;
c) said truss having an end remote from said robot supportable on a surface at another side of said area of concrete that has been partially demolished;
d) a lance movable along said truss over said area of concrete;
e) a source of liquid supplying liquid to said lance, said lance carrying a nozzle through which said liquid is sprayed onto said area of concrete.

2. The apparatus of claim 1, wherein said robot is supported on movable wheels.

3. The apparatus of claim 2, wherein said robot is controlled by a controller whereby said robot's location is moved an incremental distance each time said lance moves a prescribed distance along said truss.

4. The apparatus of claim 3, wherein said prescribed distance comprises said lance moving along said truss from adjacent said robot to said remote end of said truss and back to a location adjacent said robot.

5. The apparatus of claim 1, wherein said nozzle is rotatable.

6. The apparatus of claim 1, wherein said remote end of said truss is supported on said surface by a rotatable wheel.

7. The apparatus of claim 3, wherein said incremental distance comprises one inch.

8. The apparatus of claim 5, wherein said nozzle is rotated by hydraulic fluid supplied under pressure to a motor to which said nozzle is attached.

9. The apparatus of claim 1, wherein said liquid comprises water.

10. The apparatus of claim 1, wherein said nozzle is angled about 25° with respect to a vertical axis.

11. The apparatus of claim 1, wherein new concrete poured over said area of concrete after said robot and truss have traversed said area of concrete has a 7-day tensile strength of at least 145 psi.

12. The apparatus of claim 9, wherein water pressure exiting said nozzle comprises up to 20,000 psi.

13. The apparatus of claim 5, wherein said nozzle is rotated from 75 to 300 rpm.

14. The apparatus of claim 12, wherein said nozzle is rotated from 75 to 300 rpm.

15. The apparatus of claim 13, wherein said nozzle is angled about 25° with respect to a vertical axis.

16. A method of removing microfractures from concrete subjected to impact methods of concrete demolition, including the steps of:
a) providing an apparatus comprising:
i) a robot that is movable under control of an operator to one side of said area of concrete;
ii) a truss mounted to a side of said robot and extending horizontally;
iii) said truss having an end remote from said robot supportable on a surface at another side of said area of concrete that has been partially demolished;
iv) a lance movable along said truss over said area of concrete;
v) a source of water supplying water to said lance, said lance carrying a nozzle through which said water is sprayed onto said area of concrete;
b) moving said robot along said one side of said area of concrete;
c) moving said lance along said truss;
d) supplying water under pressure to said nozzle;
e) rotating said nozzle while said nozzle sprays water under pressure onto said area of concrete.

17. The method of claim 16, wherein said step of moving said robot comprises moving said robot an incremental distance then stopping said robot, and, while said robot is stopped, moving said lance along said truss while water under pressure is supplied to said nozzle.

18. The method of claim 17, further including the step of supporting said end of said truss remote from said robot on a rotatable wheel.

19. The method of claim 16, wherein said supplying step comprises supplying water at a pressure of up to 20,000 psi.

20. The method of claim 16, wherein said rotating step comprises rotating said nozzle at 75-300 rpm.
